(19) United States
(12) Patent Application Publication
(10) Pub. No.: US 2011/0316996 A1
(43) Pub. Date: Dec. 29, 2011

(54) CAMERA-EQUIPPED LOUDSPEAKER, SIGNAL PROCESSOR, AND AV SYSTEM

(75) Inventors: Kazutaka ABE, Osaka (JP); Shuji Miyasaka, Osaka (JP); Masaharu Matsumoto, Osaka (JP); Shinichi Akiyoshi, Osaka (JP); Takeshi Fujita, Osaka (JP); Shuhei Yamada, Osaka (JP)

(73) Assignee: Panasonic Corporation, Osaka (JP)

(21) Appl. No.: 13/224,632

(22) Filed: Sep. 2, 2011

Related U.S. Application Data
(63) Continuation of application No. PCT/JP2010/001328, filed on Feb. 26, 2010.

(30) Foreign Application Priority Data
Mar. 3, 2009 (JP) 2009-048981

(51) Int. Cl. H04N 7/18

(52) U.S. Cl. 348/77; 348/E07.085

(57) ABSTRACT

An AV system includes a camera-equipped loudspeaker provided with a camera. The camera is united with a loudspeaker body, and captures an image in a direction in which the loudspeaker body outputs a sound. The recognition unit recognizes a location of a listener from an image of the camera, and detects an orientation of the loudspeaker body relative to the listener. The sound control unit performs signal processing on a given sound signal for generating an output signal, and outputs the output signal as an acoustic signal to the loudspeaker body.

### CROSS-REFERENCE TO RELATED APPLICATION

This is a continuation of PCT International Application PCT/JP2010/001328 filed on Feb. 26, 2010, which claims priority to Japanese Patent Application No. 2009-048981 filed on Mar. 3, 2009. The disclosures of these applications including the specifications, the drawings, and the claims are hereby incorporated by reference in their entirety.

### BACKGROUND

The present disclosure relates to techniques for performing sound reproduction preferable for listeners in audiovisual (AV) systems.

Sound propagation varies depending on the locational relationship between a sound source and a listener and the environment surrounding the sound source and the listener. Accordingly, the listener senses the difference in sound propagation to perceive the location of the sound source and an impression of the environment. For example, in a situation where the location of the sound source is fixed in front of the listener, a left sound when the listener faces to the right, or a right sound when the listener faces to the light, is relatively turned up, and reaches an external auditory meatus earlier (which causes a level difference between ears and a time difference between ears). The shape of an auricle has different influences on frequency characteristics of an incoming sound depending on the incoming direction of the sound. Accordingly, the listener can perceive the presence of the sound source more clearly with characteristics (e.g., frequency characteristics) of a sound received by both ears and a change of the sound received by both ears.

A sound transfer characteristic between the entrance of an external auditory meatus and a sound source is called a head related transfer function (HRTF), and is known to have a significant influence on sound localization (i.e., the ability of identifying the origin of a sound) by a human being. In recent years, AV systems, such as home theater systems, capable of reproducing highly realistic sound with multi-channel loudspeakers such as 5.1 ch or 7.1 ch loudspeakers by utilizing the sound localization ability of a human being have become widespread among consumers.

In such an AV system, a loudspeaker is generally recommended to face toward a listener at a predetermined location on a circle about the listener. The loudspeaker, however, cannot always be placed at a recommended location because of limitations on, for example, space for installation of the loudspeaker. In this case, the following problem arises.

First, it is difficult to reproduce a sound in a manner intended by a content creator. Specifically, in a situation where the location of a loudspeaker is different from the recommended location, for example, the direction of an incoming sound perceived by a listener does not always coincide with an expected direction. This incoincidence affects not only a sound produced by this loudspeaker but also a balance with a sound produced by another loudspeaker. Accordingly, the sound impression on the listener might greatly differ from that intended by the content creator.

In addition, even in a situation where the loudspeaker is placed at the recommended location, if the listener does not hear at the recommended location or has been moved from the recommended location, a similar problem occurs.

To solve the problems, Japanese Patent Publication No. H06-311211 shows a sound reproduction device including: a location detecting part for detecting the locations of a plurality of loudspeakers and a viewer in real time; and a control part for outputting sound signals to the loudspeakers. The control part calculates a locational relationship between the viewer and each of the loudspeakers based on a detection result from the location detecting part, and sets the timing of outputting a sound signal to each of the loudspeakers from the calculation result, thereby controlling a reproduced sound.

Japanese Patent Publication No. 2003-32776 describes a method for controlling a reproduced sound by detecting, with a camera, the direction in which a listener faces or the number of listeners, and switching a filter coefficient for sound image control according to the location of the listener obtained with the camera.

### SUMMARY

The conventional techniques described above, however, have the following drawbacks.

First, in the technique described in Japanese Patent Publication No. H06-311211, a relative locational relationship between a listener and a loudspeaker is detected, and the timing of outputting a sound signal is controlled based on the detected locational relationship. That is, only the location of the loudspeaker relative to the listener is taken into consideration in controlling sound reproduction. In the technique described in Japanese Patent Publication No. 2003-32776, a reproduced sound is merely controlled according to the location of the listener obtained with the camera.

However, sound reproduction is affected not only by the locational relationship between the listener and the loudspeaker. For example, the orientation of the loudspeaker relative to the listener greatly affects perception of a sound. This is because the directional characteristics of the loudspeaker vary depending on the frequency. The loudspeaker is originally designed to have a balance of frequency characteristics with respect to a sound received in front of the loudspeaker. However, since the directional characteristics of the loudspeaker vary depending on the frequency, when a sound is received at a side or the rear of the loudspeaker, for example, the balance of the frequency characteristics is disturbed, thus failing to exhibit original acoustic performance of the loudspeaker.

Thus, to achieve optimum sound reproduction, the orientation of the loudspeaker relative to the listener also needs to be reflected on control of sound reproduction. In addition, in view of movement of the listener during listening, it is preferable to allow information on the orientation of the loudspeaker relative to the listener to be acquired in real time in order to enable dynamic control.

It is therefore an object of the present disclosure to achieve control of sound reproduction, while allowing the orientation of a loudspeaker relative to a listener to be dynamically reflected on an AV system.

In a first aspect of the present disclosure, a camera-equipped loudspeaker includes a loudspeaker body; and a camera united with the loudspeaker body, and configured to capture an image in a direction in which the loudspeaker body outputs a sound.

In this aspect, the camera united with the loudspeaker body can acquire an image in a direction in which the loudspeaker body outputs a sound. From this image, an image processing technique can recognize the location of a listener and detect the orientation of the loudspeaker body relative to the listener. Accordingly, the use of the camera-equipped loudspeaker can achieve control on sound reproduction with the orientation of the loudspeaker relative to the listener dynamically reflected thereon.

In a second aspect of the present disclosure, a signal processor for the camera-equipped loudspeaker of the first aspect includes: a recognition unit configured to receive an image signal output from the camera, recognize a location of a listener from an image shown by the image signal, and detect an orientation of the loudspeaker body relative to the listener based on the recognized location of the listener; and a sound control unit configured to perform signal processing on a given sound signal for generating an output signal, and output the output signal as an acoustic signal to the loudspeaker body.

In this aspect, from an image taken by the camera of the camera-equipped loudspeaker, the recognition unit can recognize the location of the listener and detect the orientation of the loudspeaker body relative to the listener. Accordingly, it is possible to achieve control on sound reproduction with the orientation of the loudspeaker relative to the listener dynamically reflected thereon.

In a third aspect of the present disclosure, an AV system includes: a loudspeaker body; a camera united with the loudspeaker body, and configured to capture an image in a direction in which the loudspeaker body outputs a sound; and a recognition unit configured to receive an image signal output from the camera, recognize a location of a listener from an image shown by the image signal, and detect an orientation of the loudspeaker body relative to the listener based on the recognized location of the listener; and a sound control unit configured to perform signal processing on a given sound signal for generating an output signal, and output the output signal as an acoustic signal to the loudspeaker body.

In this aspect, the camera united with the loudspeaker body can acquire an image in a direction in which the loudspeaker body outputs a sound. From this image, the recognition unit can recognize the location of the listener and detect the orientation of the loudspeaker body relative to the listener. Accordingly, it is possible to achieve control on sound reproduction with the orientation of the loudspeaker relative to the listener dynamically reflected thereon.

Accordingly to the present disclosure, the use of the camera-equipped loudspeaker can achieve control on sound reproduction with the orientation of the loudspeaker relative to the listener dynamically reflected thereon, thus achieving sound reproduction more appropriate for a listener.

### BRIEF DESCRIPTION OF THE DRAWINGS

FIG. 1 is a view illustrating an example of a configuration of an AV system according to a first embodiment.

FIG. 2 illustrates an example of an appearance of a camera-equipped loudspeaker.

FIG. 3 is a view for describing detection of angle information in processing of a recognition unit.

FIGS. 4A and 4B are views for detection of location information in the processing of the recognition unit.

FIGS. 5A and 5B are graphs showing an example of directional characteristics of a loudspeaker.

FIG. 6 shows an example of a data table of correction gains in equalizer processing.

FIG. 7 is a view for describing a relationship between the distance from a sound source and the amount of sound attenuation.

FIG. 8 shows an example of a data table of correction gains for attenuation correction.

FIG. 9 shows an example of a processing block in a sound control unit.

FIG. 10 shows an example of a configuration of an AV system according to a second embodiment.

FIGS. 11A and 11B show an example of a data table of filter correction coefficients.

FIG. 12 shows an example of a configuration of an AV system according to a third embodiment.

FIG. 13 shows an example of a configuration of an AV system according to a fourth embodiment.

### DETAILED DESCRIPTION

Embodiments of the present disclosure will be described in detail hereinafter with reference to the drawings.

### First Embodiment

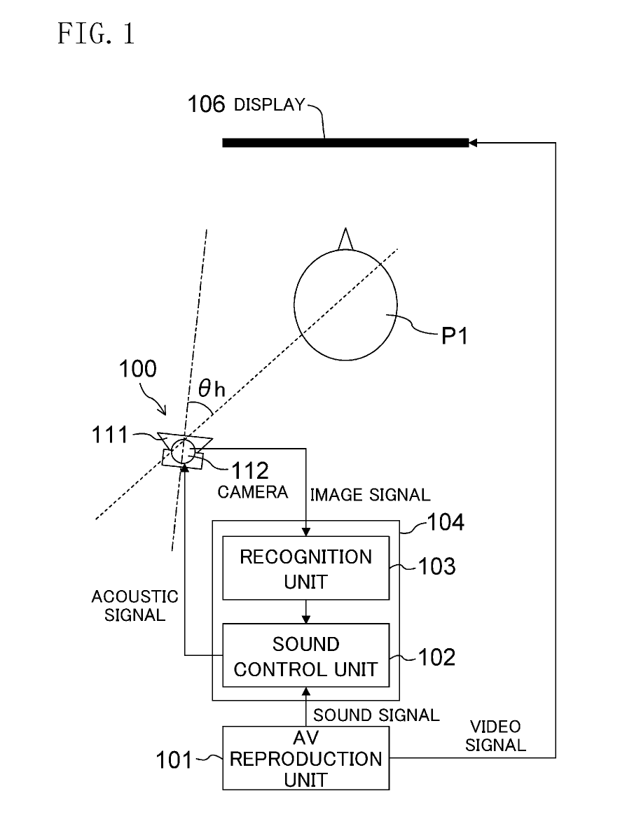

FIG. 1 illustrates an example of a configuration of an AV system according to a first embodiment. The AV system illustrated in FIG. 1 employs a camera-equipped loudspeaker 100 including a loudspeaker body 111 and a camera 112 united with the loudspeaker body 111. The camera 112 captures an image in the direction in which the loudspeaker body 111 outputs a sound. A signal processor 104 for the camera-equipped loudspeaker 100 includes a sound control unit 102 and a recognition unit 103. An image signal output from the camera 112 is given to the recognition unit 103 of the signal processor 104. An AV reproduction unit 101 reproduces AV contents, and outputs a sound signal and an image signal. The sound signal is given to the sound control unit 102 of the signal processor 104. The image signal is sent to a display 106.

In the signal processor 104, the recognition unit 103 recognizes the location of a listener P1 from an image shown by an image signal output from the camera 112, and based on the recognized listener location, detects the orientation of the loudspeaker body 111 relative to the listener P1. For example, an angle θh formed by the front direction (indicated by a dash-dotted line in FIG. 1) of the loudspeaker body 111 and a line (indicated by a broken line in FIG. 1) connecting the loudspeaker body 111 and the listener P1 is obtained. The sound control unit 102 performs signal processing on the received sound signal, and outputs the resultant signal as an acoustic signal to the loudspeaker body 111. In this signal processing, an output signal is corrected based on previously measured directional characteristics of the loudspeaker body 111 according to the orientation of the loudspeaker body 111 detected by the recognition unit 103. For example, a gain for each frequency is adjusted.

Although FIG. 1 shows only one camera-equipped loudspeaker 100, a plurality of loudspeakers are generally provided in an AV system. It is sufficient that part of, or all of, the loudspeakers is/are camera-equipped loudspeaker(s). A signal may be transmitted through wires or without wires.

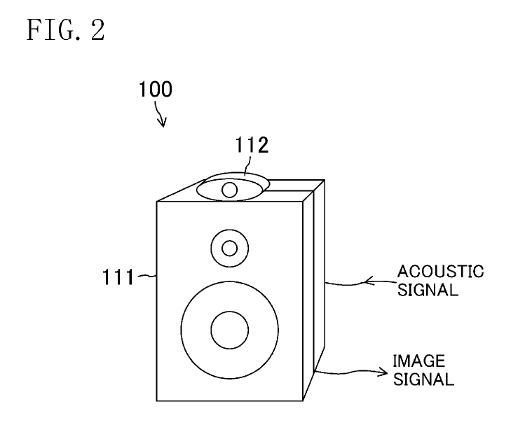

FIG. 2 illustrates an example of an appearance of the camera-equipped loudspeaker 100. In the example illustrated in FIG. 2, the camera 112 is placed on the loudspeaker body 111 to face in the same direction as the loudspeaker body 111. A loudspeaker is placed to face toward a listener in general, and thus, the configuration as illustrated in FIG. 2 enables the camera 112 to capture an image of the listener.

The camera of the camera-equipped loudspeaker is not necessarily placed in the manner as shown in the example of FIG. 2, and may be placed in other ways as long as an image of the listener can be captured. For example, the camera may be incorporated in a front portion of the loudspeaker such that only a lens thereof is exposed to the outside. A wide-angle lens such as a fish-eye lens may be used. Such a lens can expand a shooting range, and thus, the listener is more likely to be within a camera view, and the camera can be selectively placed in a wider area. For example, the camera may be placed such that a lens is exposed at a corner of an upper portion of the loudspeaker.

Alternatively, a plurality of cameras may be provided. This configuration can expand a shooting range, and thereby, the listener is more likely to be within the camera view. In addition, the use of information captured by the plurality of cameras can increase the accuracy in detecting the location of the listener.

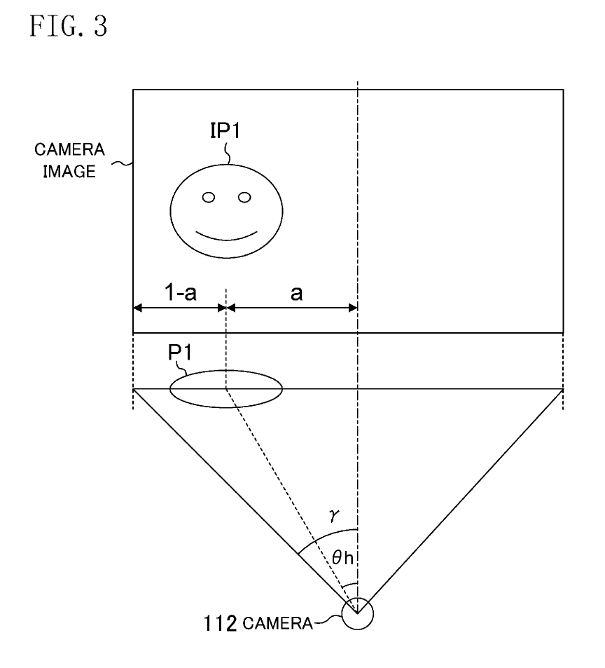

Referring now to FIG. 3, processing in the recognition unit 103 will be described. In FIG. 3, a camera image includes a face image IP1 of the listener P1. The horizontal angle of view of the camera 112 is 2γ. The recognition unit 103 detects the face image IP1 from the camera image with an image recognition technique. For example, signal processing is performed on the camera image signal to detect an outline through edge detection or parts of the face such as eyes or hair through color detection, thereby detecting the face image IP1. Such a face recognition technique has been already applied to digital cameras in recent years, and is not described in detail here.

Then, the location of the face image IP1 in the horizontal direction of the camera image is obtained. In this embodiment, the center of the face image IP1 is located at a distance of a (where 0<a<1 and the width of the camera image in the horizontal direction is 2) from the center of the camera image to the left. Suppose that the angle formed by the front direction (indicated by a dash-dotted line in FIG. 3) of the camera 112 and a line (indicated by a broken line in FIG. 3) connecting the camera 112 and the listener P1 is θh, the angle θh is obtained as:

θh=γ*a

where a is the length described above. In a different aspect, this angle θh indicates the direction of the loudspeaker body 111 in the horizontal direction relative to the listener P1 (where the orientation of the loudspeaker body 111 and the orientation of the camera 112 are already known).

If the face image IP1 is included in the right half of the camera image, the angle θh can also be detected in the same manner. Through the same process, an angle θv in the vertical direction can be detected. The foregoing process allows the recognition unit 103 to detect the orientation of the loudspeaker body relative to the listener P1.

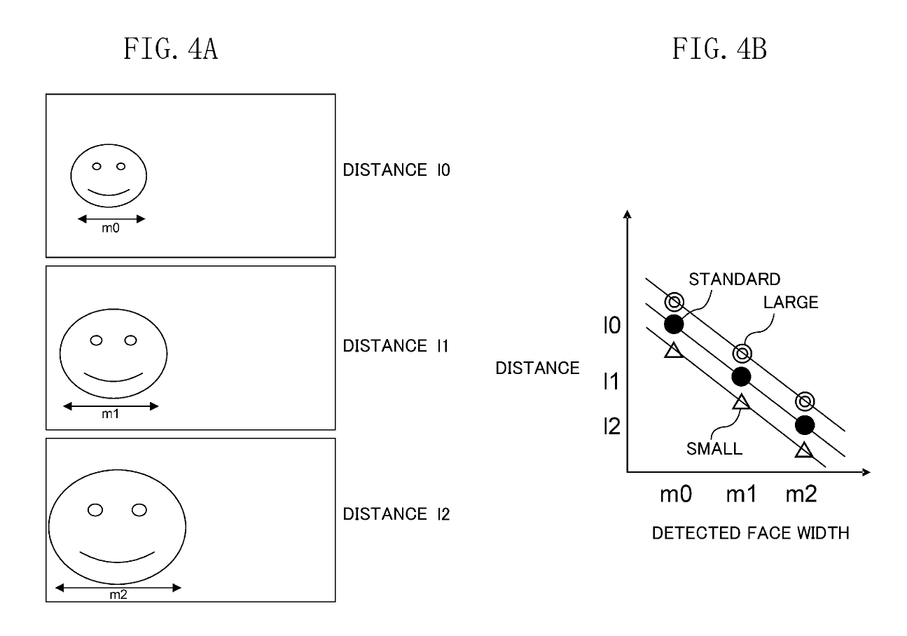

Then, an example of a method for estimating the distance L between a loudspeaker and the listener P1 will be described with reference to FIGS. 4A and 4B. FIG. 4A schematically illustrates how the size of a human face in a camera image varies depending on the distance. The face widths m0, m1, and m2 are associated with the distances l0, l1, and l2, respectively. FIG. 4B is a graph showing a relationship between the detected face width and the distance L. The graph as shown in FIG. 4B can be obtained by previously measuring the face widths on the images at some points of the distance L, and drawing lines or curves interpolating or extrapolating the measured points. The recognition unit 103 stores a relationship as shown in FIG. 4B using, for example, formula approximation, and estimates the distance L using the face width detected from the image.

The heads of the actual users do not always have a standard size, and may have sizes larger or smaller than the standard size. Thus, as shown in FIG. 4B, three patterns respectively associated with the standard, large, and small sizes of the heads are previously prepared in the graph. The head size of a listener obtained by, for example, measurement or a self-report is input, and one of the patterns of standard, large, and small sizes is selected according to the input size. The classification of the head size is, of course, not limited to standard, large, and small, and the head size may be classified into groups at 1-cm intervals so that patterns as described above are prepared for the respective groups.

The method for estimating the distance L between the loudspeaker and the listener P1 is not limited to the method described above, and may be a method for calculating the distance L based on image information from two cameras whose locations are known, or a method for estimating the distance L based on a focus position at which the listener is detected by auto-focus of a camera.

In the manners described above, the recognition unit 103 can detect location information (i.e., the angles θh and θv and the distance L) of the listener P1 using an image signal output from the camera 112. In particular, since the camera 112 is united with the loudspeaker body 111, the location of the listener P1 relative to the loudspeaker body 111 can be easily detected. This configuration can provide more appropriate sound reproduction than that in conventional configurations.

Then, processing in the sound control unit 102 will be described. As illustrated in FIG. 1, the sound control unit 102 performs signal processing on a sound signal from the AV reproduction unit 101, and outputs the signal as an acoustic signal to the loudspeaker body 111. Then, the sound control unit 102 receives location information (i.e., the angles θh and θv and the distance L) of the listener P1 detected by the recognition unit 103, and performs signal processing according to the received information.

First, a method for using direction information θh and θv will be described. Here, the use of the direction information θh and θv for signal processing on a sound signal allows correction of an output signal based on directional characteristics of the loudspeaker body 111. Specifically, in this embodiment, an output signal is corrected based on the directional characteristics of the loudspeaker body 111 according to the orientation of the loudspeaker body 111 relative to the listener P1.

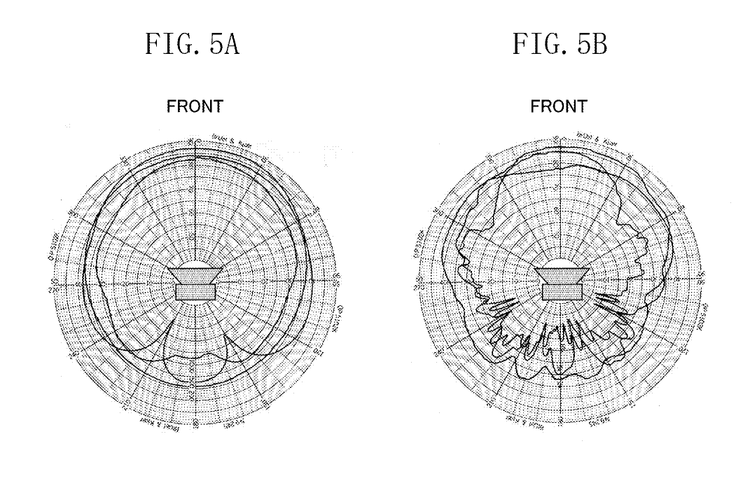

FIGS. 5A and 5B are graphs showing directional characteristics of a loudspeaker. In each of FIGS. 5A and 5B, axes radiating from the center of a circle indicate the intensities of a sound, and the intensity of a sound in each direction, i.e., directional characteristics, is shown by a solid line. The top of the graph is a front direction (i.e., a forward direction) of a loudspeaker. The directional characteristics vary depending on the frequency of a reproduced sound. In FIG. 5A, directional characteristics associated with 200 Hz, 500 Hz, and 1000 Hz are plotted. In FIG. 5B, directional characteristics associated with 2 kHz, 5 kHz, and 10 kHz are plotted.

As shown in FIGS. 5A and 5B, a sound has the highest intensity in the front direction of the loudspeaker, and broadly stated, the intensity of the sound decreases toward the back (i.e., the direction 180° opposite to the front). This change in the sound intensity varies depending on the frequency of a reproduced sound. Specifically, the amount of change is small at a low frequency, and the amount of change increases as the frequency increases. In general, the sound quality of a loudspeaker is adjusted such that the sound is best balanced when the listener is located in the front direction. The directional characteristics as shown in FIGS. 5A and 5B show that when the location of the listener shifts from the front direction of the loudspeaker, frequency characteristics of a received sound greatly differ from ideal characteristics, and the balance of the sound is disturbed. Similar problems also occur in phase characteristics of a sound.

To solve these problems, the directional characteristics of the loudspeaker are measured to previously calculate an equalizer for correcting an influence of the directional characteristics, and equalizer processing is performed according to detected direction information θh and θv, i.e., the orientation of the loudspeaker body relative to the listener. This processing enables well-balanced reproduction independent of the orientation of the loudspeaker relative to the listener.

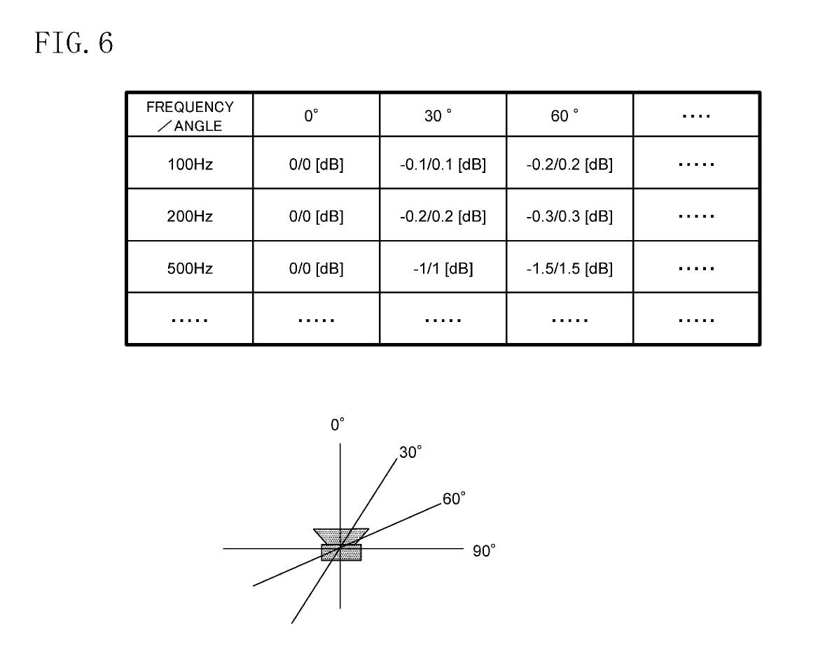

Referring now to FIG. 6, specific equalizer processing will be described. FIG. 6 shows an example of sound pressure levels (i.e., a number at the left in each cell) and correction gains (i.e., a number at the right in each cell) of an equalizer for each angle relative to the front of the loudspeaker and each frequency. The unit is dB. In the example of FIG. 6, the correction gain for the sound pressure level is set for each angle and each frequency, thereby allowing the listener to receive the same sound at any place as that received in the front direction of the loudspeaker. In other words, the use of the correction gains shown in FIG. 6 can form an approximately complete circle of a graph of directional characteristics for each frequency. It should be noted that the example shown in FIG. 6 is merely an example, and the angle and the frequency may be set in further detail, for example. Alternatively, when the detected angle is not included in data, the correction gains may be calculated by, for example, interpolation.

The foregoing description is directed to the directional characteristics on a horizontal plane, but the directional characteristics of a loudspeaker are defined on a sphere surrounding the loudspeaker. Thus, the table shown in FIG. 6 is extended so that correction gains are set for the angle θh in the horizontal direction and the angle θv in the vertical direction. This extension allows correction of the directional characteristics according to the orientation of a loudspeaker relative to a listener to be performed in three dimensions.

To perform equalizer processing, it is sufficient for the sound control unit 102 to include an analog filter or a digital filter such as an IIR filter and an FIR filter. For example, if a parametric equalizer is used for correction, a Q value (i.e., a value indicating the sharpness of a peak of frequency characteristics) may be set in addition to correction gains.

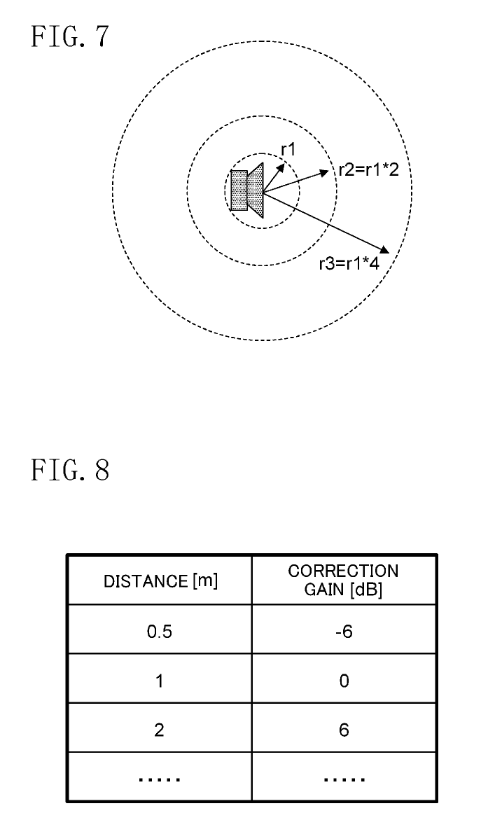

Thereafter, a method for using distance information L will be described. In a case where a sound is produced from a point, the sound propagates in all the directions, and attenuates to a degree corresponding to the propagation. The amount of the attenuation is inversely proportional to the square of the distance. For example, as shown in FIG. 7, if the distance from a sound source doubles, e.g., from r1 to r2 (=r1×2), the sound pressure becomes ¼(=(½)²). If the distance from the sound source quadruples, e.g., to r3 (=r1×4), the sound pressure becomes 1/16 (=(¼)²). That is, as the distance from a listener to a loudspeaker increases, the sound pressure of a sound perceived by the listener decreases. In this case, the sound volume balance deteriorates under the influence of the sound pressure from another loudspeaker, and the sound received by the listener disadvantageously differs in sound localization, for example, from a sound intended by a content creator.

To prevent this unwanted situation, gain correction is performed on a sound produced by a loudspeaker according to detected distance information L. This gain correction enables well-balanced reproduction even in a case where the distance between the listener and the loudspeaker is not optimum.

The relationship between the distance and the attenuation described here holds in the presence of an ideal point sound source (i.e., a dimensionless nondirectional theoretical sound source) and an ideal free sound field. In practice, the sound source is not a point sound source, i.e., has dimensions and directivity. In addition, a sound field has various reflections, and thus, is not a free sound field. Accordingly, for an actual loudspeaker or actual reproduction environments, correction gains associated with the respective distances as shown in FIG. 8 are previously measured and held. If the detected distance L is not included in data, an approximate value of a correction gain is calculated by, for example, interpolation approximation.

The correction gain may be set for each frequency. A sound having a high frequency component is known to show a large amount of attenuation depending on the distance, as compared to a sound having a low frequency component. Accordingly, if a data table as shown in FIG. 8 is prepared for each frequency, sound pressure correction can be performed with higher accuracy. Such sound pressure correction for each frequency can be achieved by band division with, for example, a QMF filter bank and gain setting. For this correction, an IIR digital filter or an FIR digital filter, for example, is generally employed.

Alternatively, correction may be performed by equalizing the sound pressure levels of a plurality of loudspeakers. For example, in a case where loudspeakers are located at distances of r1, r2, and r3, respectively, shown in FIG. 7 to the listener, the sound volume of the loudspeaker at the distance r1 is reduced and the sound volume of the loudspeaker at the distance r3 is increased so that the sound volumes of these loudspeakers become equal to that of the loudspeaker at the distance r2. This correction can equalize the volumes of sounds from the respective loudspeakers to the listener. The sound volumes may, of course, be corrected with reference to the sound volume of another loudspeaker or to the sound volume of a completely different component. If the loudspeakers have different efficiencies, the sound volumes may be adjusted in consideration of the difference in efficiency.

Such correction by the sound control unit 102 according to angle information θh and θv and distance information L can achieve better sound reproduction even in a case where the orientation of a loudspeaker does not face toward the listener or a case where the distance from a loudspeaker to the listener is not optimum.

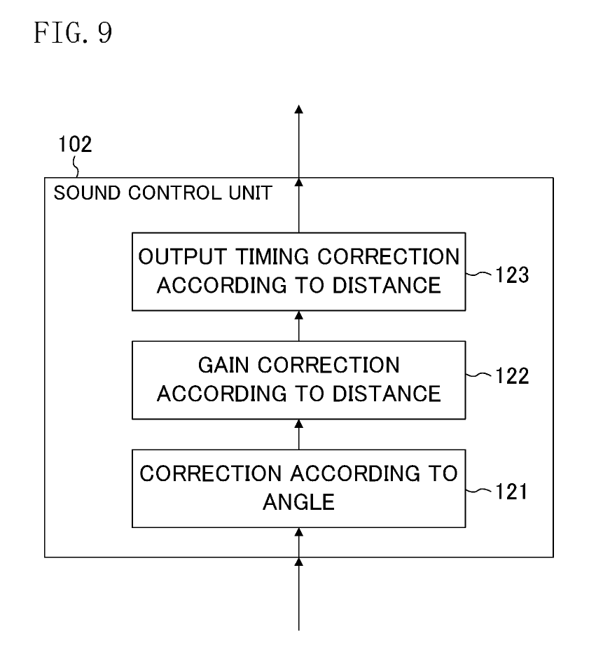

FIG. 9 shows an example of a processing block in the sound control unit 102. In FIG. 9, the sound control unit 102 includes three processing blocks 121, 122, and 123. The processing block 121 performs correction according to angle information as described above. The processing block 122 performs gain correction according to the distance as described above. The processing block 123 corrects the output timings of sounds according to detected distances such that the output timings of sounds from a plurality of loudspeakers coincide at the location of the listener.

In this embodiment, correction values for each angle and each distance are obtained as gains for the entire band or each frequency. Alternatively, each correction value may be held as a correction FIR filter to be used for correction. The use of an FIR filter enables phase control so that more accurate correction can be performed.

Then, an example of operation timings of image shooting by the camera 112, detection processing by the recognition unit 103, and correction by the sound control unit 102 will be described.

For example, the camera 112 always takes photographs, and continuously outputs an image signal to the recognition unit 103. The recognition unit 103 always detects the location of a listener from an image signal, and continuously outputs location information on the listener to the sound control unit 102 in real time. The sound control unit 102 receives location information which is output in real time, switches correction processing in real time, and continuously corrects an acoustic signal. In this manner, even when the location of the listener dynamically changes, sound control can follow this change.

In such control, however, correction processing switches even with a small movement of the listener, and causes a change only to an inaudible degree in some cases. Such switching of the correction processing is meaningless in terms of audibility. To avoid such switching, location information on a listener may be output to the sound control unit 102 only when the recognition unit 103 detects a movement (e.g., a change in angle or distance) of the listener to a degree larger than or equal to a predetermined threshold value, for example.

Alternatively, image shooting by the camera 112 and detection processing by the recognition unit 103 may be performed at predetermined time intervals. This operation can reduce a processing load in the system. Alternatively, the recognition unit 103 and the sound control unit 102 may execute processing when a user turns a trigger switch on with, for example, a remote controller. This operation can further reduce a processing load in the system.

Alternatively, the initial value of location information on a listener may be previously set by, for example, performing a measurement mode included in a system, for example, such that subsequent dynamic correction caused by movement of the listener can be performed using an image signal output from the camera 112.

The correction data table as described in this embodiment is recorded in, for example, a nonvolatile memory in the sound control unit 102.

Since an actual AV system includes a plurality of loudspeakers, application of the technique described here to each of the loudspeakers enables control to be performed on a sound reproduced by the loudspeaker according to the user location.

### Second Embodiment

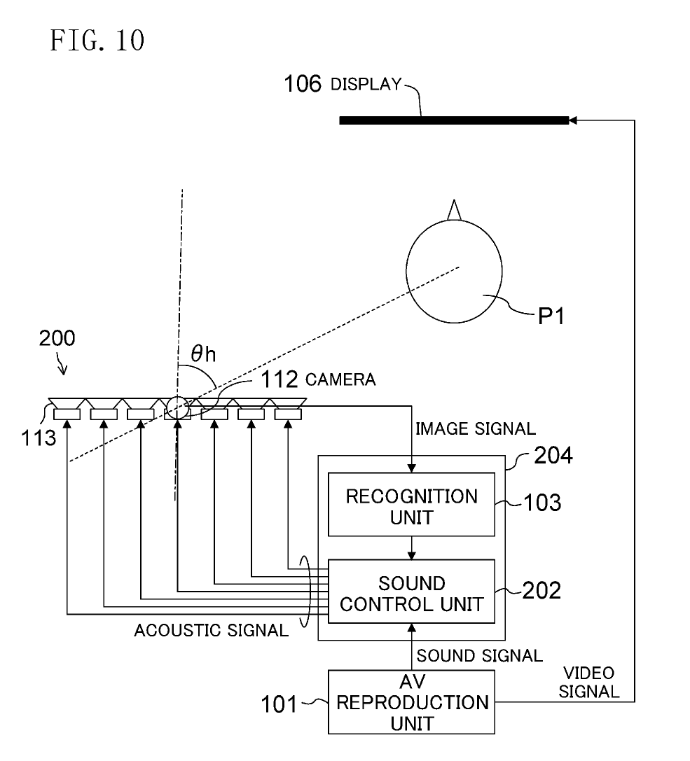

FIG. 10 illustrates an example of a configuration of an AV system according to a second embodiment. In FIG. 10, components already shown in FIG. 1 are denoted by the same reference characters, and explanation thereof is not repeated.

In the configuration illustrated in FIG. 10, a loudspeaker body of a camera-equipped loudspeaker 200 is an array loudspeaker 113 made of a plurality of loudspeaker units. The array loudspeaker can achieve sharp directional characteristics by increasing the number of loudspeaker units and the length of the units (see Nishikawa et al., “Directional Array Speaker by Using 2-D Digital Filters,” the Institute of Electronics, Information and Communication Engineers (IEICE) Transactions A vol. J78-A No. 11 pp. 1419-1428, November, 1995). Application of this technique to sound reproduction is expected to prevent diffusion of a sound into unnecessary directions. To achieve this expectation, it is necessary to orient the peak of the directivity of the array loudspeaker 113 toward the listener.

In this embodiment, the array loudspeaker 113 is provided with a camera 112, and in a signal processor 204, a recognition unit 103 detects the orientation of the array loudspeaker 113 relative to a listener. This detection can be achieved in the same manner as in the first embodiment. Then, a sound control unit 202 performs signal processing on a sound signal such that the peak of the directivity of the array loudspeaker 113 is directed to the listener, and outputs acoustic signals to the respective loudspeaker units.

The direction of the peak of the directivity of the array loudspeaker 113 can be easily controlled, for example, with settings of delays and gains to be added to acoustic signals to the respective loudspeaker units. Specifically, to shift the direction of the peak of the directivity slightly to the right, for example, a delay of an acoustic signal to a left loudspeaker unit is reduced and a gain of this acoustic signal is increased so that a sound is output more quickly at a larger volume.

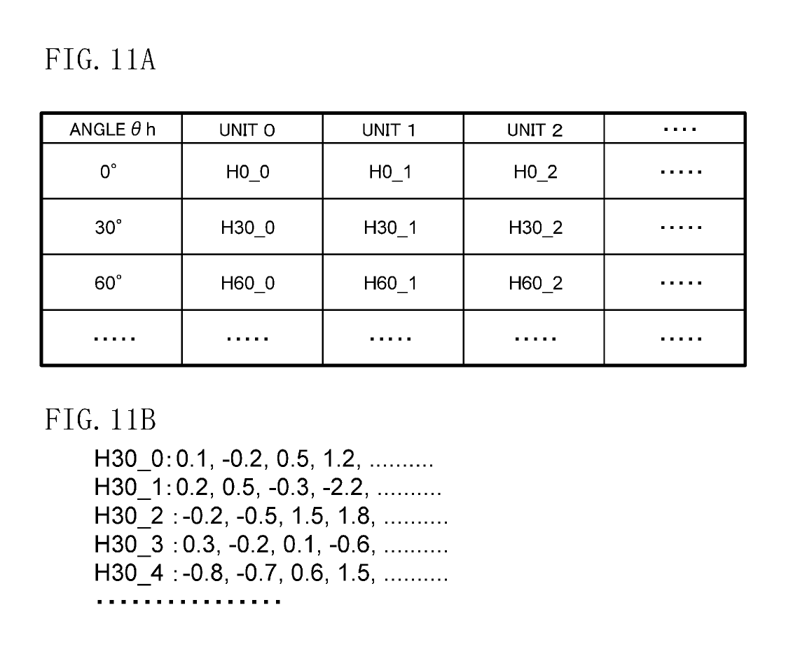

In addition, to direct the peak of the directivity of the array loudspeaker 113 to a listener P1 with higher accuracy, a data table for holding, for each angle, an FIR filter coefficient for use in sound control on each loudspeaker unit as shown in FIGS. 11A and 11B may be used. FIG. 11A shows an angle θh and the FIR filter coefficient Hx_y (where x is an angle θh and y is a loudspeaker unit number) for each loudspeaker unit. FIG. 11B shows an example of FIR filter coefficients of the respective loudspeaker units where the angle θh is 30°. For example, a data table as shown in FIGS. 11A and 11B is stored in a nonvolatile memory in the sound control unit 202, and the sound control unit 202 reads an FIR filter coefficient from the data table according to angle information θh detected by the recognition unit 103, thereby achieving sound control.

The foregoing description is directed to directivity control on a horizontal plane, but the use of a loudspeaker array in which loudspeaker units are arranged in a vertical direction enables directivity control according to angle information θv in a vertical direction to be achieved in the same manner.

The loudspeaker units may be arranged in a plane. In this case, directivity control according to angle information on each of the horizontal and vertical directions can be achieved.

As in the first embodiment, in control according to distance information L, gain correction according to the distance may be performed on acoustic signals of the respective loudspeaker units.

In the case of using an array loudspeaker, so-called localized reproduction can be performed, and this embodiment may be applied to control on this localized reproduction. The localized reproduction is such reproduction that a sound is reproduced only in a predetermined region and the sound volume rapidly decreases at a location apart from this region. For example, in a case where the camera 112 detects the location of the listener P1 and it is found that the listener P1 is located out of an expected region, the sound control unit 202 switches a control parameter to perform control such that the location of the listener P1 is included in the region of the localized reproduction.

### Third Embodiment

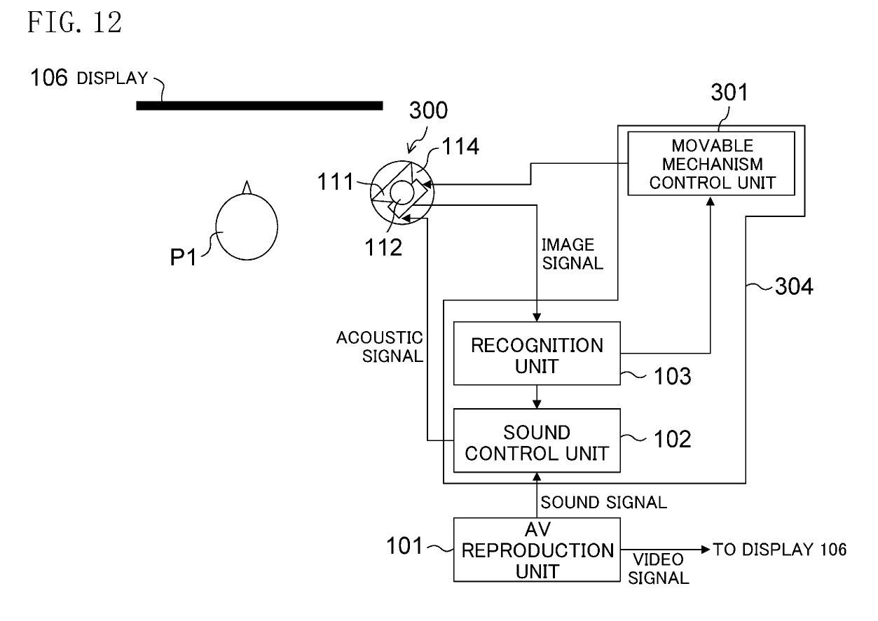

FIG. 12 illustrates an example of a configuration of an AV system according to a third embodiment. In FIG. 12, components already shown in FIG. 1 are denoted by the same reference characters, and explanation thereof is not repeated.

In the configuration illustrated in FIG. 12, a camera-equipped loudspeaker 300 includes a movable mechanism 114 for changing the orientation of a loudspeaker body 111. The movable mechanism 114 can be provided as an electric rotating table, for example. A signal processor 304 includes a movable mechanism control unit 301 for controlling the movable mechanism 114. The recognition unit 103 outputs location information on a listener P1 detected from an image signal to the movable mechanism control unit 301 in addition to a sound control unit 102. The movable mechanism control unit 301 receives location information on the listener P1, and sends a control signal to the movable mechanism 114 such that a loudspeaker body 111 faces toward the listener P1. Such operation enables the orientation of the loudspeaker body 111 to be dynamically matched with the location of the listener P1.

Control of actually changing the orientation of the loudspeaker as described above may be performed in combination with the correction processing on directional characteristics of a loudspeaker described in the first embodiment. Specifically, for example, control may be performed in such a manner that the correction processing on directional characteristics is employed if the angle information θh and θv indicating the orientation of the loudspeaker body 111 relative to the listener P1 is less than or equal to a predetermined threshold value, and the orientation of the loudspeaker is changed by the movable mechanism 114 if the angle information θh and θv exceeds the predetermined threshold value. When the orientation of the loudspeaker greatly deviates from the listener, a large correction gain needs to be given in order to correct the directional characteristics. However, if the correction gain is increased, the problem of an overflow occurs in digital signals, and distortion might occur in a sound because of a reproduction upper limit gain of the loudspeaker itself. Accordingly, a combination of control of this embodiment with correction of directional characteristics can avoid such a problem.

This embodiment is also applicable to the array loudspeaker of the second embodiment. Specifically, the array loudspeaker may be provided in the movable mechanism so that the movable mechanism is controlled to change the orientation of the array loudspeaker. This configuration enables directivity control or control for localized reproduction.

### Fourth Embodiment

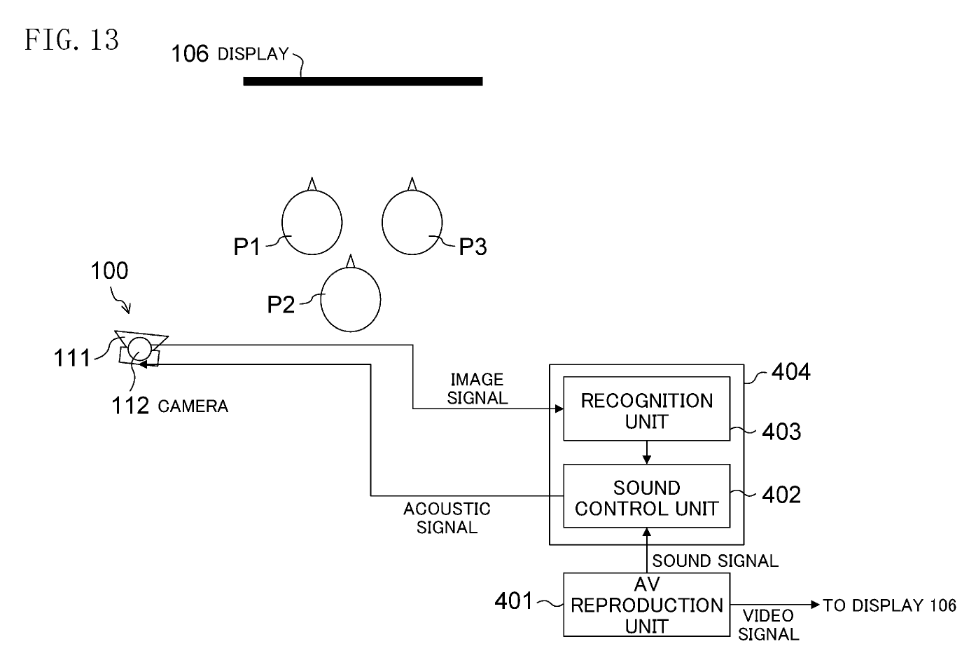

FIG. 13 illustrates an example of a configuration of an AV system according to a fourth embodiment. In FIG. 13, components already shown in FIG. 1 are denoted by the same reference characters, and explanation thereof is not repeated.

In the configuration illustrated in FIG. 13, in a signal processor 404, a recognition unit 403 recognizes the locations of listeners P1, P2, and P3 from an image shown by an image signal output from a camera 112, and detects the number of listeners. Then, as in the first embodiment, location information is detected with respect to each of the listeners P1, P2, and P3. When the recognition unit 403 detects a plurality of listeners P1, P2, and P3, a sound control unit 402 performs signal processing using a locational relationship among the listeners P1, P2, and P3 in addition to the orientation of the loudspeaker body 111. For example, if a plurality of listeners are present in a predetermined angle region when viewed from the loudspeaker body 111, control of directional characteristics is performed on one of the listeners located at the center. If only one of the listeners is located away from the others, control of directional characteristics is performed on the other listeners, or correction itself is not performed. In this manner, if a plurality of listeners are present, signal processing is performed according to the locational relationship among the listeners, thereby achieving more appropriate reproduction.

In detecting the number of listeners from a camera image, if a plurality of listeners overlap when viewed from the loudspeaker, for example, a plurality of listeners might be recognized as one. In this case, however, control of directional characteristics on the listeners recognized as one causes no serious problems in terms of sound quality. That is, if a plurality of listeners appear to overlap each other, the number of these listeners does not need to be strictly detected, and the processing is simplified accordingly.

The foregoing embodiments have been given mainly on correction of directional characteristics. However, other configurations, such as a configuration in which the face direction of a listener when viewed from a loudspeaker or the distance between the loudspeaker and the listener is detected and the head-related transfer function from the loudspeaker is estimated so that a sound control unit performs control, may be employed. The sound control unit previously holds a control parameter according to the face direction and the distance, and switches the control parameter according to the detection result to perform reproduction. An example of easy correction includes correction of the distance from the loudspeaker to the listener. For example, if the distance from a loudspeaker to a listener is smaller than that from another loudspeaker, the timing of producing a sound is delayed. This operation can obtain the same advantages as those obtained by extending the loudspeaker distance.

The present disclosure can provide sound reproduction more appropriate for a listener in an AV system, and thus is, useful for improvement of sound quality in, for example, home theater equipment.

What is claimed is:

1. A signal processor for the camera-equipped loudspeaker which includes a loudspeaker body and a camera united with the loudspeaker body and configured to capture an image in a direction in which the loudspeaker body outputs a sound, the signal processor comprising:
a recognition unit configured to receive an image signal output from the camera, recognize a location of a listener from an image shown by the image signal, and detect an orientation of the loudspeaker body relative to the listener based on the recognized location of the listener; and
a sound control unit configured to perform signal processing on a given sound signal for generating an output signal, and output the output signal as an acoustic signal to the loudspeaker body.

2. The signal processor of claim 1, wherein the sound control unit corrects the output signal based on directional characteristics of the loudspeaker body according to the orientation of the loudspeaker body detected by the recognition unit.

3. The signal processor of claim 1, wherein the loudspeaker body is an array loudspeaker made of a plurality of loudspeaker units, and
the sound control unit controls localized reproduction of the loudspeaker body according to the orientation of the loudspeaker body detected by the recognition unit.

4. The signal processor of claim 1, wherein the recognition unit is capable of detecting a number of listeners, and
when the recognition unit detects a plurality of listeners, the sound control unit performs signal processing according to the orientation of the loudspeaker body and a locational relationship among the listeners detected by the recognition unit.

5. The signal processor of claim 1, wherein the camera-equipped loudspeaker includes a movable mechanism configured to change an orientation of the loudspeaker body,
the signal processor includes a movable mechanism control unit configured to control the movable mechanism, and
the movable mechanism control unit controls the movable mechanism according to the orientation of the loudspeaker body detected by the recognition unit.

6. An AV system, comprising:
a loudspeaker body;
a camera united with the loudspeaker body, and configured to capture an image in a direction in which the loudspeaker body outputs a sound; and
a recognition unit configured to receive an image signal output from the camera, recognize a location of a listener from an image shown by the image signal, and detect an orientation of the loudspeaker body relative to the listener based on the recognized location of the listener; and
a sound control unit configured to perform signal processing on a given sound signal for generating an output signal, and output the output signal as an acoustic signal to the loudspeaker body.
